(19) United States
(12) Patent Application Publication
(10) Pub. No.: US 2025/0076744 A1
(43) Pub. Date: Mar. 6, 2025

(54) AFFIRMATION PROJECTOR

(71) Applicant: Sarah Gene Marshall, Williams Bay, WI (US)

(72) Inventors: Sarah Gene Marshall, Williams Bay, WI (US); Manolo Bossi, Verona (IT)

(21) Appl. No.: 18/817,696

(22) Filed: Aug. 28, 2024

Related U.S. Application Data
(60) Provisional application No. 63/579,242, filed on Aug. 28, 2023.

(51) Int. Cl. G03B 21/12; G03B 21/14

(52) U.S. Cl. CPC G03B 21/12; G03B 21/142

(57) ABSTRACT

An affirmation projector for projecting positive affirmations on a surface.

This application claims the benefits of and priority to U.S. Patent Provisional Application No. 63/579,242, filed Aug. 28, 2023, which is hereby incorporated herein by reference.

### FIELD OF THE INVENTION

This disclosure generally relates to projection devices, particularly projection devices that project positive affirmations and positive affirmation projectors that may be used as night lights.

### BACKGROUND

Nightlights and projectors are commonly used when attempting to fall asleep, relax or relieve stress. Such lights can have a soothing or calming effect on the individual, particularly children.

There remains a need for improved nightlights and projectors.

### SUMMARY OF INVENTION

There are several aspects of the present subject matter which may be embodied separately or together in the subject matter claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, an affirmation projector (which may also serve as a nightlight) comprises a light projecting system that projects a plurality of positive affirmations on a surface.

### BRIEF DESCRIPTION OF DRAWINGS

FIG. 1A is a schematic illustration of one alternative affirmation projector in accordance with the present disclosure.

FIG. 1B is a schematic illustration of the affirmation projector shown in FIG. 1A.

FIG. 2 is a cross-sectional view of the affirmation projector shown in FIG. 1A.

FIG. 3A is a perspective view of another embodiment of an affirmation projector in accordance with the present disclosure.

FIG. 3B is a perspective exploded view of the affirmation projector of FIG. 3A.

FIG. 3C is a perspective view of the affirmation projector of FIG. 3A, showing an enlarged view of the projector's top portion.

FIG. 3D is a perspective view of the affirmation projector of FIG. 3A, shown with the cap removed.

FIG. 3E is a perspective view of the affirmation projector of FIG. 3A.

FIG. 3F is a front view of another embodiment of an affirmation projector in accordance with the present disclosure.

FIG. 3G is a perspective exploded view of the affirmation projector of FIG. 3F.

FIG. 3H is a side view of the affirmation projector of FIG. 3F.

FIG. 3I is a rear view of the affirmation projector of FIG. 3F.

FIG. 3J is a perspective view of the affirmation projector of FIG. 3F, shown with the top portion moved/rotated relative to the base.

FIG. 4A is a perspective view of another embodiment of an affirmation projector in accordance with the present disclosure.

FIG. 4B is a side view of the affirmation projector of FIG. 4A, showing tilting of the body relative to the base.

FIG. 4C is a rear view of the affirmation projector of FIG. 4A.

FIG. 4D is a side view of the affirmation projector of FIG. 4A.

FIG. 4E is a perspective view of the affirmation projector of FIG. 4A, shown with the cap removed.

FIG. 5A is a perspective view of another embodiment of the affirmation projector in accordance with the present disclosure.

FIG. 5B is a side view of the affirmation projector of FIG. 5A.

FIG. 5C is a perspective view of the affirmation projector of FIG. 5A.

FIG. 5D is a front view of the affirmation projector of FIG. 5A.

FIG. 6A is a perspective view of another embodiment of an affirmation projector in accordance with the present disclosure.

FIG. 6B is a side view of the affirmation projector of FIG. 6A.

FIG. 6C is a perspective view of the affirmation projector of FIG. 6A.

FIG. 6D is a front view of the head of the affirmation projector of FIG. 6A.

FIG. 6E is a perspective view of a portion of the head of the affirmation projector of FIG. 6A.

FIG. 7A is a perspective view of another embodiment of an affirmation projector in accordance with the present disclosure.

FIG. 7B is a side view of the affirmation projector of FIG. 7A.

FIG. 7C is a perspective view of the affirmation projector of FIG. 7A.

FIG. 7D is a front perspective view of the head of the affirmation projector of FIG. 7A.

FIG. 7E is a perspective view of the affirmation projector of FIG. 7A, shown with the cap removed.

FIG. 7B is a side view of the affirmation projector of FIG. 7A.

### DETAILED DESCRIPTION

A more detailed description of the device in accordance with the present disclosure is set forth below. It should be understood that the description of the specific devices below is intended to be exemplary and not exhaustive of all possible variations or applications. Thus, the scope of the disclosure is not intended to be limiting and should be understood to encompass variations or embodiments that would occur to persons of ordinary skill.

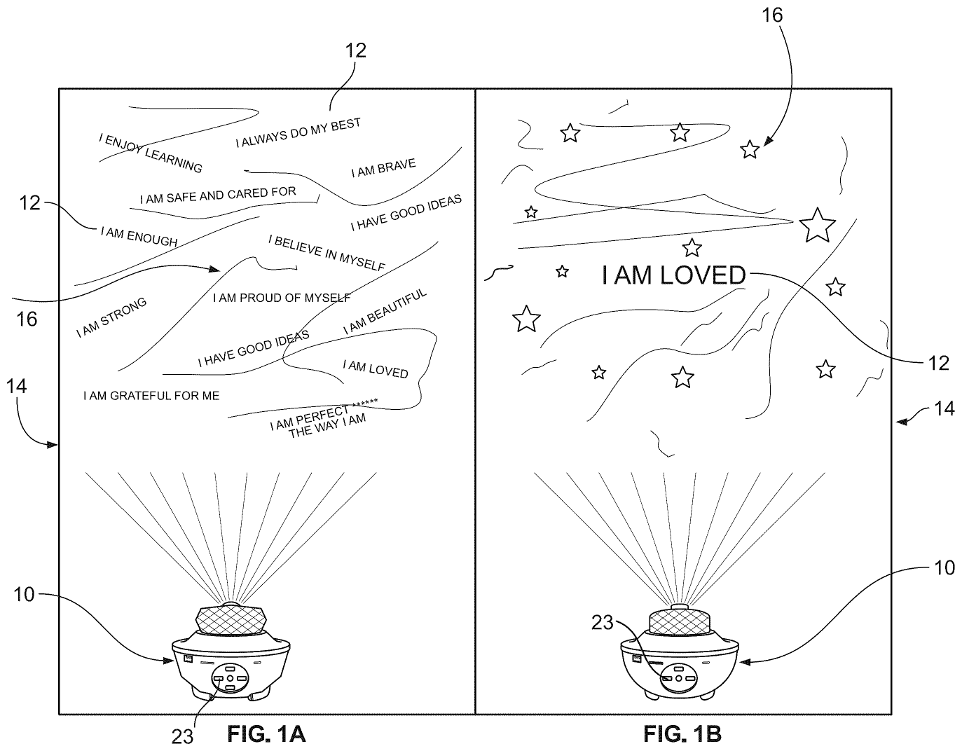

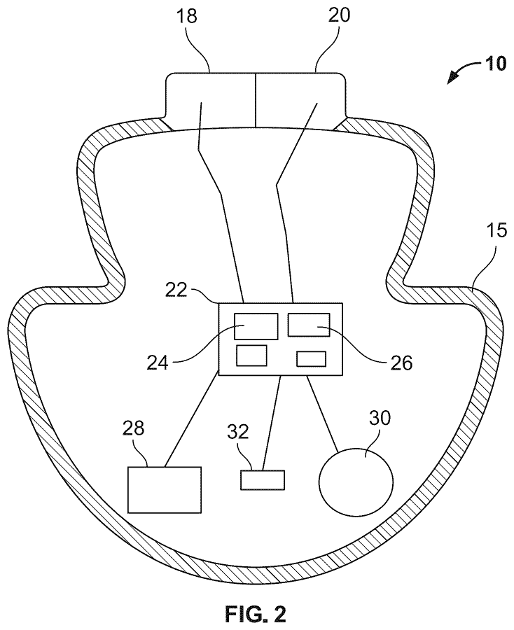

FIGS. 1A-2 illustrate one embodiment of an affirmation projector 10 that projects or displays a plurality of positive affirmations 12 on a surface 14, such as a wall, ceiling, screen, object, etc. The projected positive affirmations 12 may be sayings, mantras, statements, phrases, etc., that elicit positive thoughts or emotions. Affirmation projector 10, optionally, projects one or more background images 16 on the surface 14. When background images 16 are projection, the affirmation projector 10, projects positive affirmations 12 on or adjacent to the background image(s) 16. Background image 16 may be, for example, an image of a galaxy, a color, an image of a person, an image of an animal, an image of an object, and/or an image of a landscape.

As illustrated in FIG. 1, affirmation projector 10 may simultaneously project multiple positive affirmations 12. Positive affirmations 12 may also be displayed prominently one after another. For example, all the displayed positive affirmations 12 have an initial size. A selected positive affirmation 12 becomes a second larger size and/or has the visual effect of coming toward the viewer, while the other displayed positively affirmations maintain their initial size. This highlights, emphasizes or otherwise accentuates the selected positive affirmation 12. The relatively larger or prominent positive affirmation 12 then returns to its initial size. Then another positive affirmation 12 becomes a second larger size to be prominently displayed and returns to its initial size. This continues with the other affirmations and, optionally, repeats. The repeated sequence of affirmations may be uniform or random.

The affirmation projector 10 may be configured so that a portion of the background also becomes larger while the positive affirmation becomes larger. For example, a positive affirmation may be displayed over a star of the background image. As the positive affirmation becomes larger, so does the associated star. As the positive affirmation returns to its initial size, so does the associated star.

Referring to FIG. 2, in another embodiment, projector 10 projects positive affirmations one after the other. For instance, a first positive affirmation is displayed for a desired period of time and then disappears and is replaced with a second positive affirmation. This pattern continues as the projector cycles through a selected group of positive affirmations. The sequence of affirmations may be random or a uniform sequence.

In any embodiments described herein, the positive affirmations may do one or more of move, fade in and out, change visual appearance, color, size, font, etc. The saying, language and/or text of the positive affirmations 12 may be preprogrammed or custom. When custom, the users select or create their own language, size, script, shape, etc., of the positive affirmations and/or backgrounds. The user may also select the sequence, frequency, and timing of the projections.

Projector 10 may also include a sound device for producing sounds, such as music, voices, white noise, nature, and/or meditation sounds. The sounds may be from a custom playlist, such as a custom playlist of songs. The sound may be a custom recording that has been recorded by a recording device in the projector and is played back through the sound device. For example, the custom recording may be a loved one's voice, which is played back during the projection of the affirmations.

The affirmation projector may include a timer for turning off the affirmation projector after a set time and/or a programable clock configured to turn on the affirmation projector at a set time. The affirmation projector may be configured so that the brightness may be adjusted. For example, the projected positive affirmations and background images may be selectively adjustable to be brighter or dimmer. The affirmation projector may be operatively connected to and controlled through a phone, tablet, or computer application via wireless communication such as Wi-Fi or Bluetooth®. The projector may include a barcode to establish wireless connections and/or controls.

Turning to FIG. 2, projector 10 may have a body 15. A first light projecting element 18 for projecting the positive affirmations and, optionally, a second light projecting element 20 for projecting one or more background images are associated with body 15. The first and second light projecting elements 18, 20 may include one or more light producing elements, such as lasers, LEDs, and the like. The laser could include a single laser or plurality of lasers, such as three lasers (red, green and blue). The laser could be laser diodes, solid state DPSS, gas layers or any other suitable lasers. The first and second light projecting elements 18, 20 may also include mirrors, galvanometer scanners and other optics. The first and second light projecting elements 18, 20 are connected to a controller 22 associated with body 15. For example, the controller 22 is located within the body. The controller 22 controls the light projecting elements 18, 20 so that projected affirmations and background images are projected in any of the manners discussed above. Controller 22 includes a processor 24 and a memory 26 for storing information. A power source 28 for powering projector 10 is also associated with body 15 and operatively connected to controller 22. The power source 28 may be connected to an electrical outlet, may be batteries, or may be rechargeable. Optionally, projector 10 includes a sound device 30, such as a speaker, for producing sound. The sound device 30 is operatively connected to controller 22. The sound device 30 may produce sounds stored in memory device 26. The stored sounds may be any of those described above. The projector 10 may also include a wireless connection device 32 operatively connected to the controller 22, such as a Wi-Fi or Bluetooth®, for wireless connecting to a network, mobile device (phone or tablet), or a computer.

Referring to FIG. 1, optionally, projector 10 may include a control panel 23. The control panel 23 may be connected to controller 22 and used to control the projector 10. In one embodiment, the control panel 23 may have buttons and knobs. In another embodiment, the control panel 23 may be a touch screen. In addition to or instead of the control panel 23, the projector 10 may be operated by a remote-control device and/or may be wirelessly connected to a personal smart device (cell phone, tablet, home operating system, etc.). The personal smart device may have an application (app) that is used to control projector 10. The person smart device communicates via wireless connection device 32.

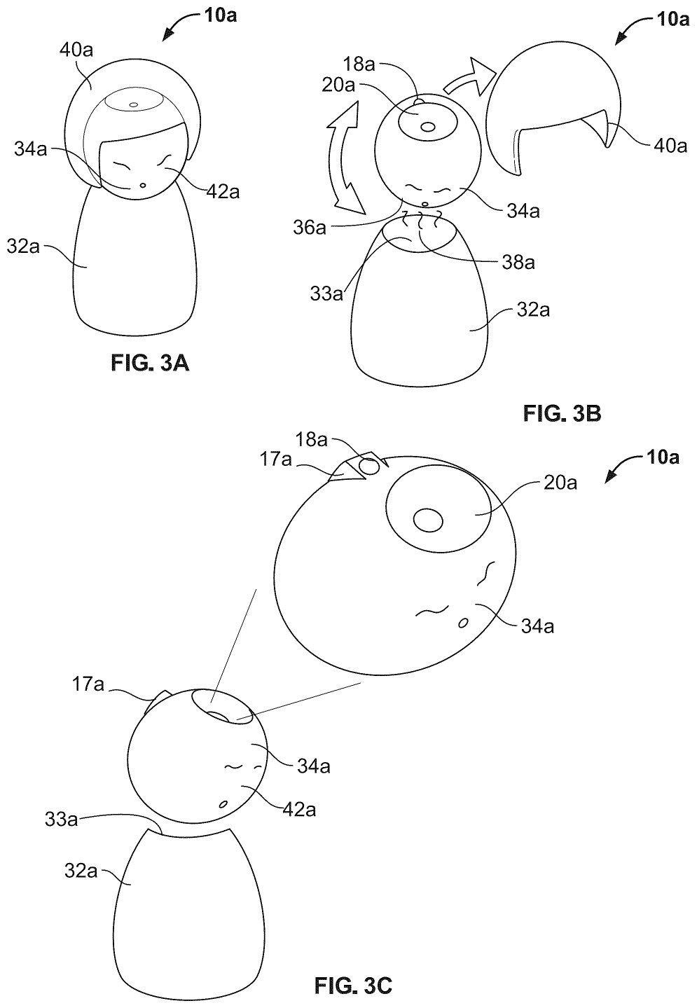

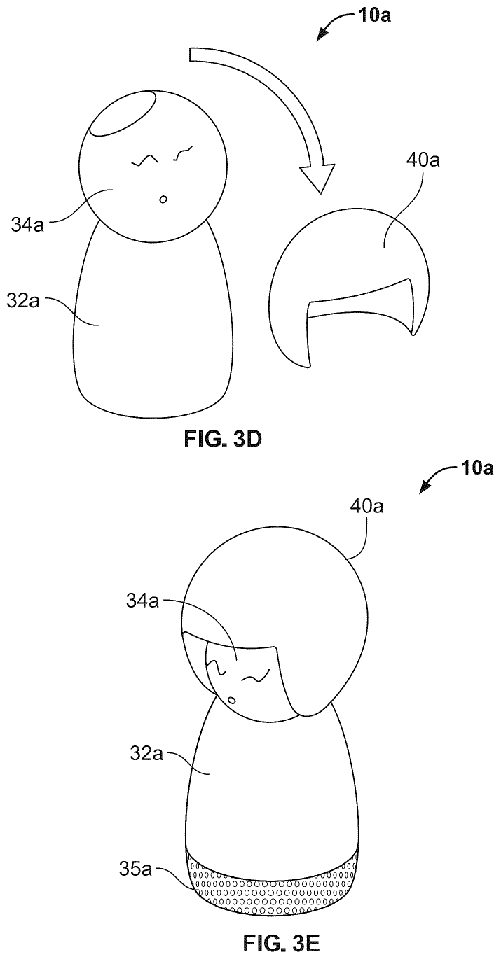

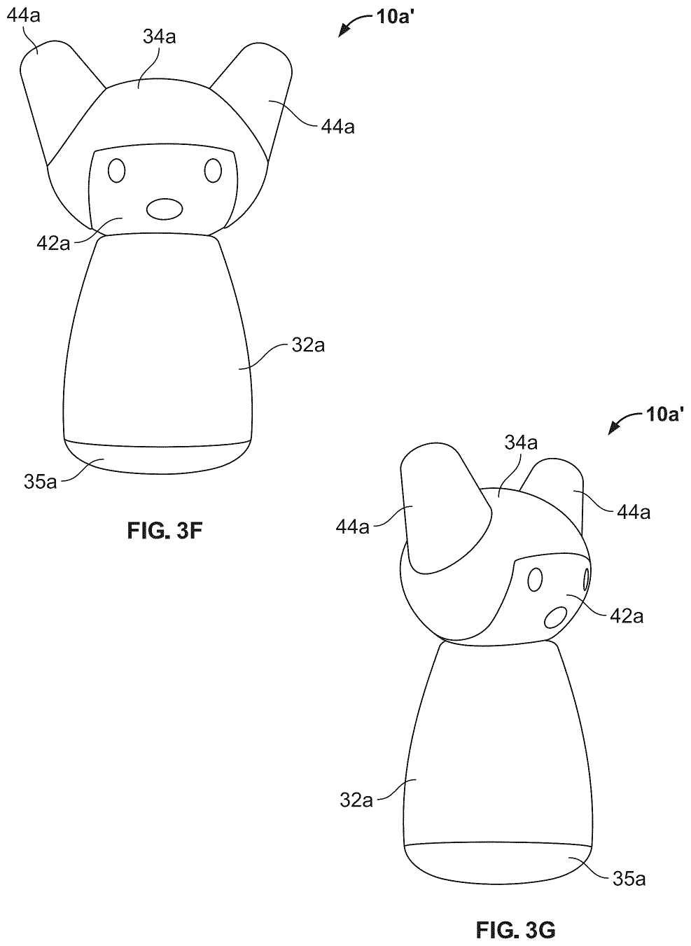

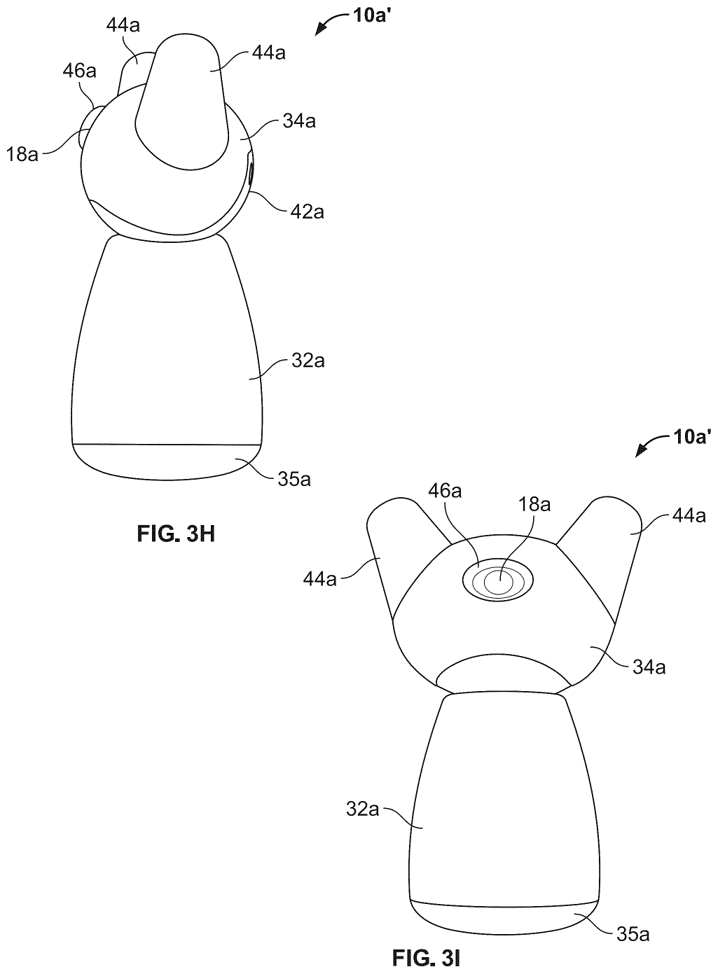

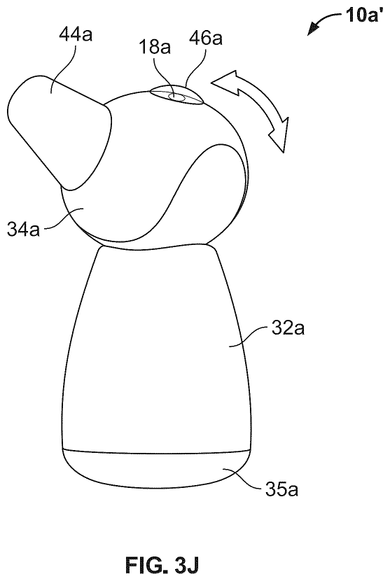

Projectors of the present disclosure may have the shape of any object or body. For example, the projector may have the shape of an animal, sports equipment, person, doll, plant, etc. Turning to FIGS. 3A-3E, in one example, projector 10a has the shape of a doll. Projection 10a has a base 32a and a top portion 34a atop base 32a. In this embodiment, base 32a is the doll's body, and top portion 34a is the doll's head. Thus, the base 32a and top portion 34a may also be referred to as the body and head, respectively. The top portion 34a includes a decorative design, such as face 42a. The first light projecting element 18a and second light projecting element 20a may be associated with top portion 34a. In the illustrated embodiment, the top portion 34a is substantially sphere shaped. The second light projecting element 20a is in the center of the top of the top portion 34a and the first light projecting element 18a is located offset from the center of the top of the top portion 34a. In this embodiment, the first light projecting element 18a is located or associated with a projection 17a extending from the sphere-shaped top portion 34a.

Also, in this embodiment, top portion 34a and base 32a are separable. Base 32a and top portion 34a may be releasable attachable, and position to one another via magnetic force. For example, one or both of base 32a and top portion 34a may include magnetic material 36a, 38a, such as magnets that attached the base 32a and top portion 34a together. The base 32a may have a seat, cradle or docketing portion 33a that mates or accepts the top portion 34a. The seat 33a may be a concaved portion of the base 32a that receives the top portion 34a. In other words, the top portion 34a sits in the concaved seat 33a. Top portion 34a may be positionable/movable relative to base 32a so that the projections of the positive affirmations and background images may be aimed in a desired direction or orientation. The top portion 34a may move in virtually any direction relative to the base 32a. For example, the top portion 34a may rotate, pivot, spin, tilt, etc. relative to the base 32a. In the illustrated embodiment, top portion 34a may rotate, pivot, spin, and/or tilt within seat 33a. Furthermore, top portion 34a may include a cap 40a, which could be for decorative purposes or could be to protect the light projecting elements 18a, 20a. In the illustrated embodiment, cap 40a has the shape or appearance of the doll's hair or hat. As shown in FIG. 3A, the cap 40a may cover the lighting elements 18a, 20a and other portions of the top portion 34a.

Turning to FIG. 3E, projector 10a, and any of the projectors disclosed herein, may optionally, have a speaker 35a. As mentioned above, the speaker 35a may be used to emit sounds, such as a music or a customized message.

FIGS. 3F-3J illustrate another embodiment of projector 10a′, which is like projector 10a shown in FIG. 3A. Similar to the projector shown in FIG. 3A, projector 10a′ has a base 32a and a top portion 34a atop base 32a. Base 32a is the doll's body and top portion 34a is the doll's head. Also, base 32a and top portion 34a may also be connected to magnets. In other embodiments, the base 32a and top portion 34a may be connected in any other suitable manner. In some embodiments, top portion 34a may rest in the seat or cradle 33a of the base 32a without any attachment, e.g., without magnets.

Top portion 34a includes a decorative face 42a and projections 44a. In the illustrated embodiment, projections 44a appear as hair or ears. At least one light projecting element 18a is located at the back of the top portion 34a. Optionally, the projector 10a′ may include a second light projecting element. A transparent cover 46a may cover the light projecting element(s) 18a. In the illustrated embodiment, cover 46a extends out from the outer surface of the top portion 34a. However, in other embodiments, cover 46a may be flush with the outer surface of the top portion.

Referring to FIG. 3J, like projector 10a shown in FIGS. 3B and 3C, the top portion 34a of projector 10a′ may move in virtually any direction relative to the base 32a to direct or aim the projection of the affirmation. For example, the top portion 34a may rotate, pivot, spin, tilt, etc. relative to the base 32a. Additionally, projector 10a may, optionally, include a speaker 35a.

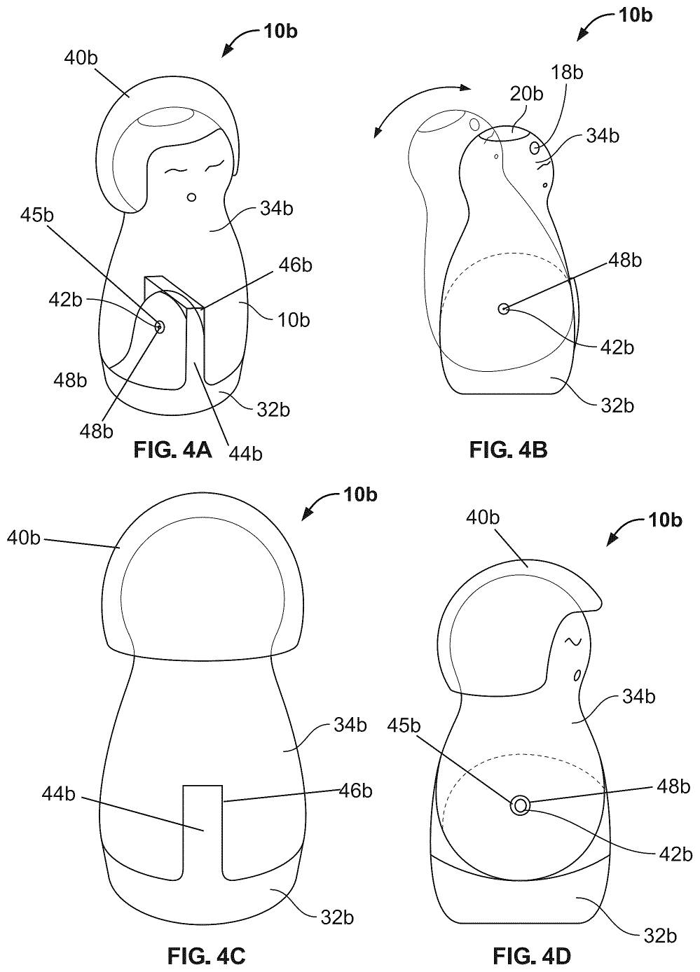

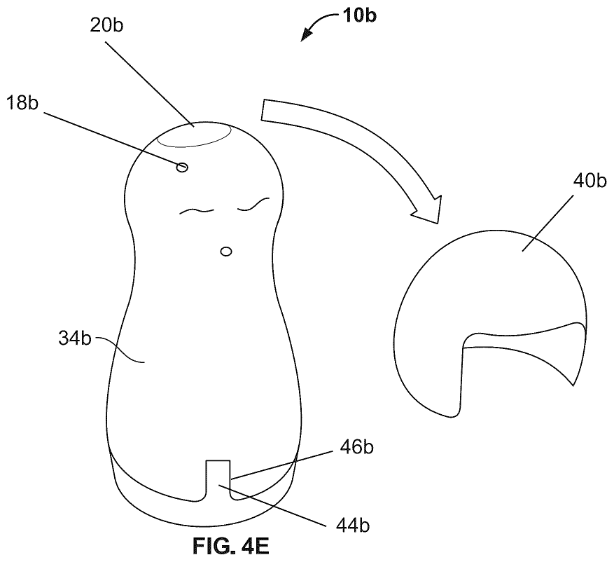

FIGS. 4A-4E illustrate another embodiment of an affirmation projector 10b. In this embodiment, base 32b and top portion 34b are connected to each other at a pivot joint or hinge 42b. Top portion 34b is movable relative to base 32b, so first and second light projecting elements 18b and 20b may be selectively aimed. Projector 10b may also include a removable cap 40b, as shown in FIG. 4E.

In the illustrated embodiment, the base 32b and top portion 34b are connected by a pivot joint 42b. Base 32b includes an upright 44b that extends upward. The top portion 34b includes a gap 46b at the bottom of the top portion. The upright 44b is in the gap 46b, and the upright 44b includes a bore or hole 45b for receiving one or more pins 48b. The pin(s) 48b may extend from the wall of the top portion 34b defining the gap 46b. As shown in FIG. 4B, the top portion 34b is pivotable relative to base 32b.

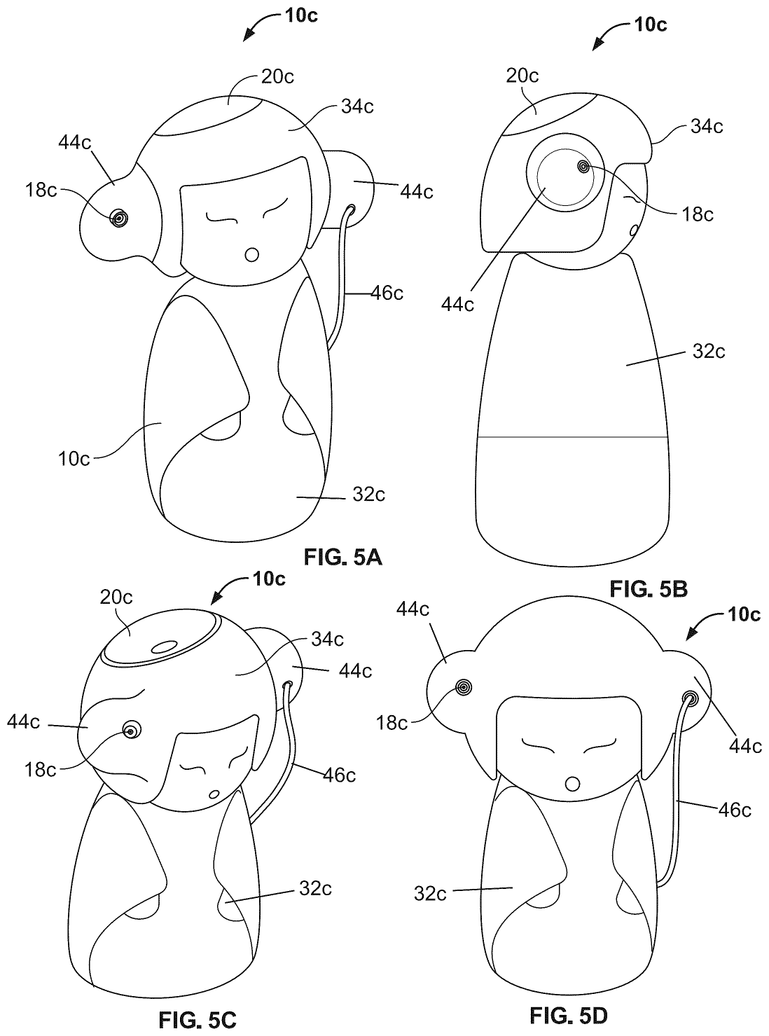

FIGS. 5A-5D illustrate another embodiment of an affirmation projector 10c. In this embodiment, first light projecting element 18c may be on a side of the top portion 34c, and second light projecting element 20c may be on the top of top portion 34c. The top portion 34c is generally sphere-shaped with the second light projecting element 20c at the top of the sphere-shaped top portion. The top portion includes at least one projection 44c, projecting outward from the sphere-shaped top portion 34c. In the illustrated embodiment, the at least one projection includes two projections 44c depicting ears or hair of the doll. The first light projecting element may be in or associated with one of the projections 44c.

Like the previous embodiments, the top portion 34c, optionally, may move relative to the base 32c. Additionally, projector 10c may include a cord or wire 46c connecting between base 32c and top portion 34c. In this embodiment, the controller, wireless connection, and/or other components may be located in the base 32c, wherein the wire connects the controller, etc. to the light projecting elements 18c, 20c. In the illustrated embodiment, the wire.

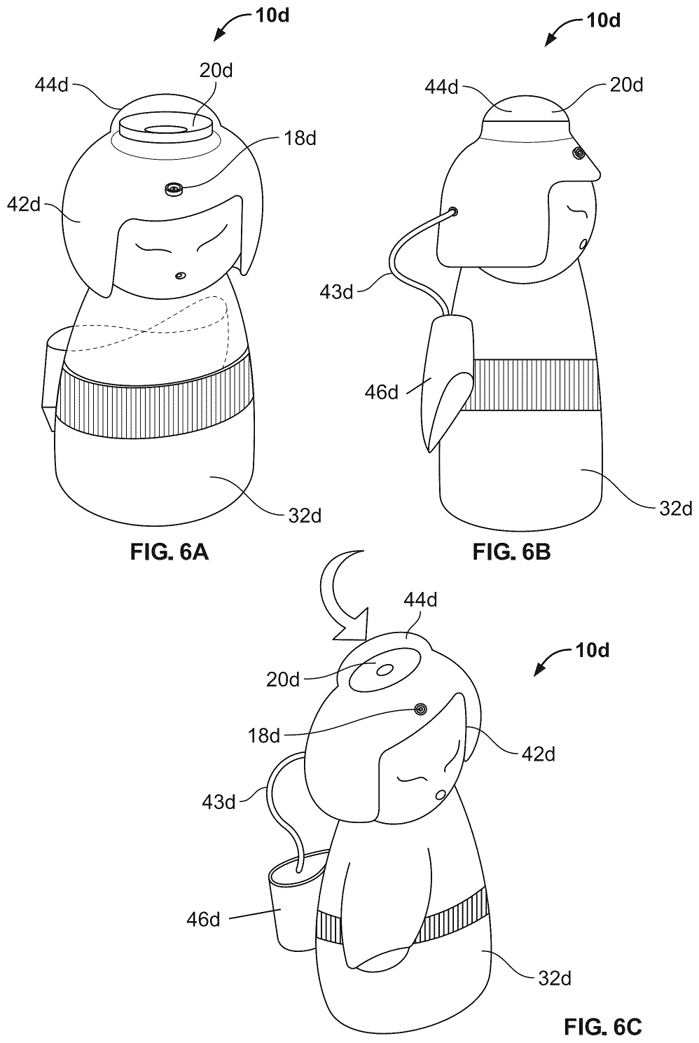

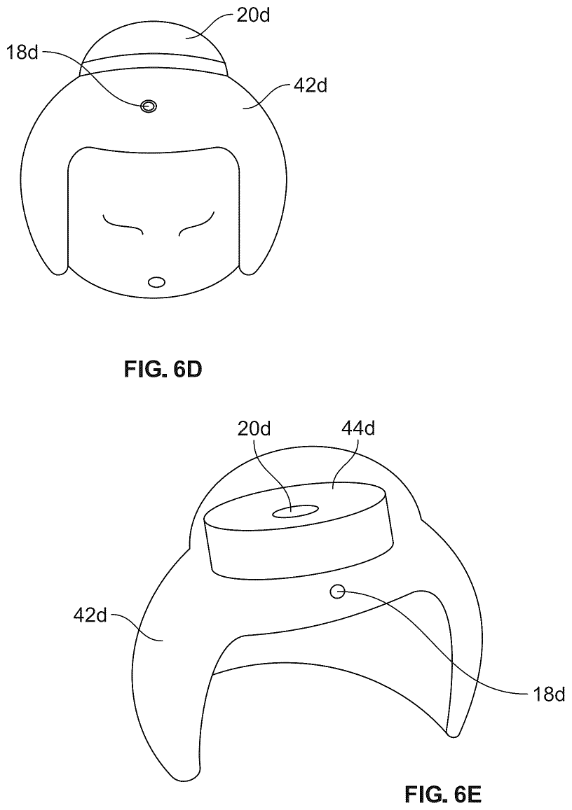

FIGS. 6A-6E illustrate another embodiment of an affirmation projector 10d. In this embodiment, first light projecting element 18d and second light projecting element 20d are in cap 42d. A cord 43d may extend from base 32d to cap 42d to connect light projecting elements 18d, 20d to the controller and power. Additionally, second light projecting element 20d may include a lens 44d that is the same color as cap 42d. The base 32d may have a projection 46d and the cord 43d extends from the projection to the cap 42d.

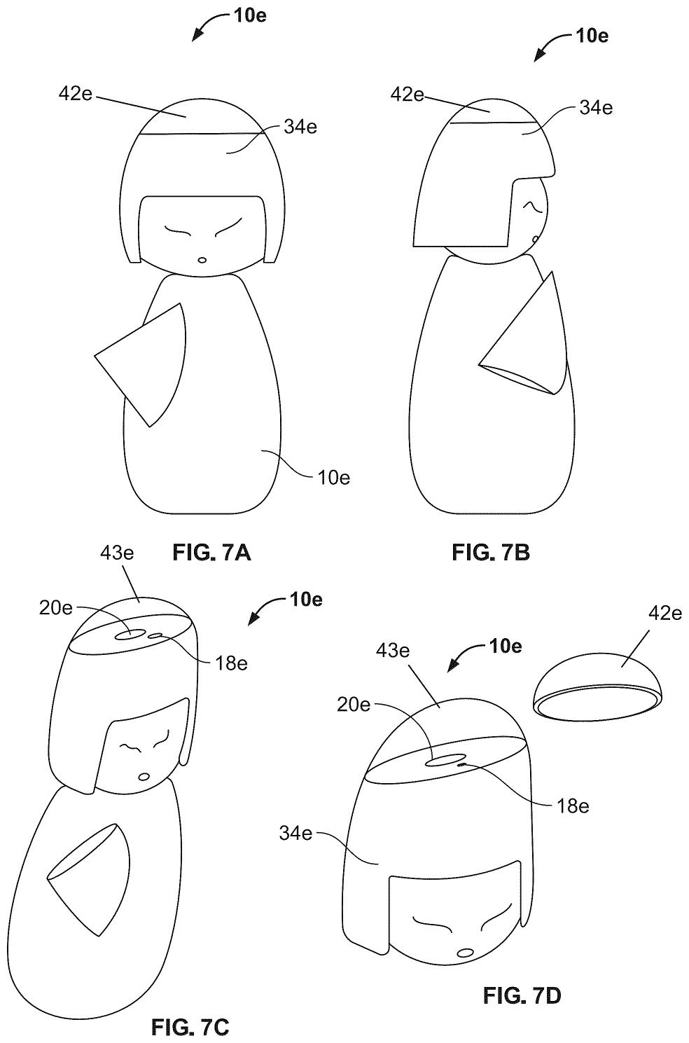

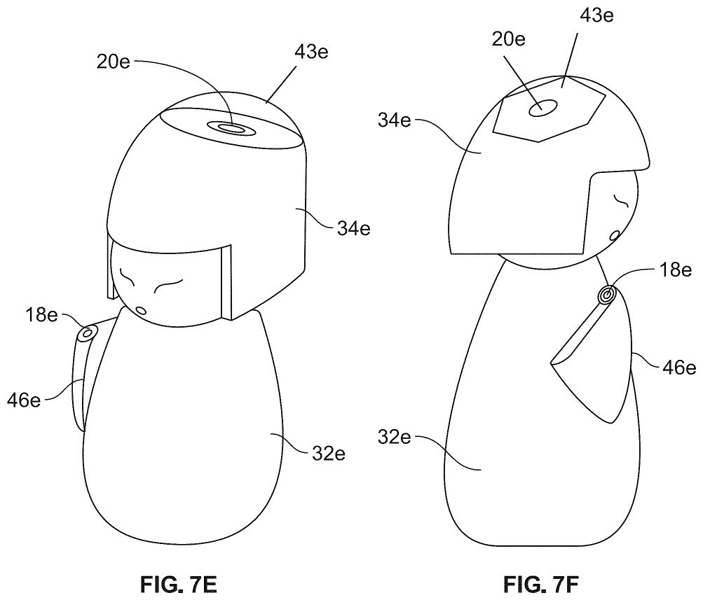

FIGS. 7A-7F illustrate another embodiment of an affirmation projector 10e. In this embodiment, first light projecting element 18e may either be in the top portion 34e with second light projecting element 20e (FIGS. 7A-7D) or first light projecting element 18e may be in base 32e (FIGS. 7E-7F). For example, the first light projecting element 18e may be in an arm 46e, which is attached or extends from base 32e. The projector 10e may include a cap 42e for covering the portion of the top portion 34e that includes light projecting element 20e. Top portion 34e may also include a transparent cover 43e over light projecting elements.

It will be understood that the embodiments and examples described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

What is claimed:

1. An affirmation projector, comprising:
a light projecting element that projects plurality of positive affirmations on a surface.

2. The affirmation projector of claim 1, wherein the positive affirmations are projected one after another.

3. The affirmation projector of claim 1, wherein multiple positive affirmations are projected simultaneously.

4. The affirmation projector of claim 3, wherein the positive affirmations are prominently displayed one after another.

5. The affirmation projector of claim 4, wherein the prominent display comprises increasing the size of a displayed positive affirmation.

6. The affirmation projector of claim 4, wherein the prominent display is for a selected period of time.

7. The affirmation projector of claim 1, wherein the light projecting element is configured so that the projected positive affirmations move, fade out and light back up, change visual appearance, change color, change size and/or font.

8. The affirmation projector of claim 1, further comprising a second light projecting element that projects one or more background images, wherein the positive affirmation is displayed on the background image.

9. The affirmation projector of claim 8, wherein the background image comprises an image of a galaxy, a color, an image of a person, an image of an animal, an image of an object, and/or an image of a landscape.

10. The affirmation projector of claim 1, wherein the positive affirmations are preprogrammed.

11. The affirmation projector of claim 1, wherein the positive affirmations are custom.

12. The affirmation projector of claim 1, further including a sound device for producing sounds.

13. The affirmation projector of claim 12, further including a recording device for recording prerecorded sounds for playback through the sound device.

14. The affirmation projector of claim 12, wherein the sounds are music, voices, white noise, nature and/or meditation sounds.

15. The affirmation projector of claim 1, further including a timer for turning off the affirmation projector after a set period of time.

16. The affirmation projector of claim 1, further including a programable clock configured to turn on the affirmation projector at a set time.

17. The affirmation projector of claim 1, wherein the projector is operatively connected to and controlled through an application on a phone, tablet or computer.

18. The affirmation projector of claim 1, further including a base and a top portion, wherein the top portion includes the light projecting element, and the top portion is movable relative to the base.

19. The affirmation projector of claim 18, wherein the base and top portion are releasably connected.

20. The affirmation projector of claim 19, wherein the base and top portion are attached by magnets.
